(19) United States
(12) Patent Application Publication
(10) Pub. No.: US 2003/0226449 A1
(43) Pub. Date: Dec. 11, 2003

(54) Coffee Filter holder

(76) Inventors: Philippe Carasso, Satigny (CH); Claude Schindler, Geneve (CH)

Correspondence Address: John Moetteli, BUGNION S.A., Case postale 375, GENEVA 12, CH-1211, CH

(21) Appl. No.: 10/328,753

(22) Filed: Dec. 23, 2002

(30) Foreign Application Priority Data
Dec. 24, 2001 (FR) 01 16813
Mar. 19, 2002 (FR) 02 03358
Apr. 25, 2002 (FR) 02 05218

(51) Int. Cl. A23F 3/00

(52) U.S. Cl. 99/279

(57) ABSTRACT

The coffee filter holder has an infusion chamber, the bottom of which has an opening allowing the coffee extract to flow through, with a filter with a bottom having a hole. The infusion chamber comprises at least:

a plate for closing off the filter bottom;

a support collaborating with the said plate for closing off the filter bottom so as to allow the said plate to be removed and the coffee extract to flow when the pressure in the filter reaches a determined level.

### BACKGROUND OF THE INVENTION

The present invention relates to a coffee filter holder comprising an infusion chamber the bottom of which has an opening to allow the coffee extract to flow through, and a filter for the coffee with a bored bottom.

The present invention also relates to a coffee machine comprising such a coffee filter holder.

Coffee filter holders are known in the prior art. By way of example, PCT international application No. WO 97/39668, the content of which is incorporated by reference in the present application, describes a filter holder for preparing a cup of coffee with a layer of froth. The assembly comprises a filter holder the bottom of which has at least one flow opening and a coffee filter. The known assembly is characterized in particular in that it comprises, on the one hand, a paper filter through which the coffee flows out of the filter and a separation plate having at least one flow opening, the said plate being situated between the underside of the filter and the bottom of the filter holder. This machine works as follows. Hot water is led into the filter holder and wets the ground coffee located in the filter. As the coffee filter comprises a filter paper, the hot water will flow through the coffee filter without the pressure in the coffee filter rising. By means of the separation plate, a high pressure is created in the space between the separation plate and the coffee filter. The coffee extract is forced through openings in the plate so that bubbles are formed in the space on the other side of the separation plate to the coffee filter.

European patent application No. 0 459 323, the content of which is incorporated by reference in the present application, describes a filter holder for a coffee machine of the expresso type. This coffee filter comprises a bowl accommodating a coffee filter the bottom of which is perforated, an infusion collecting chamber comprising a corridor the mouth of which communicates with a dispensing funnel. Furthermore, the filter holder described comprises a froth generating device consisting of a flexible blade arranged transversely to the mouth, one end of which is anchored in the chamber and the other of which is applied with a certain force against the said mouth so as to obtain an infusion jet only when the pressure in the chamber is higher than the force with which the free end of the blade is pressed against the mouth, together with a partition arranged around the blade and extending downwards so that the infusion jet is atomized on the partition, thereby forming froth.

European patent No. 0 749 283, the content of which is incorporated by reference in the present application, finally describes a coffee filter cartridge for a machine of the expresso type. In this cartridge, a pressure chamber is formed between two plates, one of the plates consisting of the filter plate of the cartridge. The pressure is created by the presence of holes, whose small size opposes the flow of the coffee extract, thus forming this pressure chamber.

### SUMMARY OF THE INVENTION

The object of the invention is to improve the known devices.

More specifically, the object of the invention is to create a coffee filter holder generating quality and durable froth, the said filter holder being both simple to manufacture, to fit and to remove so as to allow it to be cleaned.

In a first embodiment, the filter holder comprises at least moving means for shutting off the filter bottom, pressure means acting on the said means for closing off the filter bottom so as to allow the said closure means to be removed and the coffee extract to flow when the pressure in the filter reaches a determined level.

As a preference, the said moving closure means comprise a first plate and the said pressure means comprise at least one sprung element. The first plate may have at least one opening. In an alternative form, the first plate has several openings distributed around its circumference.

The filter holder may comprise a second plate having at least one opening, the said pressure means acting between the said second plate and the said first plate. As a preference, the openings are in the form of a venturi.

The plate may possibly have at least one concentric groove on its opposite face to the coffee receptacle. In addition, the coffee receptacle may be a reusable filter or a disposable coffee prepackaged dose, such as a cartridge.

According to another embodiment, the bottom of the infusion chamber is equipped with a plate pressing against a central protrusion and leaving passages between the said plate and the interior wall of the infusion chamber so that the coffee extract can flow, the said plate being mounted in the said infusion chamber in such a way that it can rock with respect to the said protrusion in a direction approximately parallel to the axis of the infusion chamber, the dimensions of the filter leaving clearance between its lateral surface and the interior wall of the infusion chamber, while the height of the filter is designed so that the filter experiences compression when the filter holder and filter assembly is mounted on the machine and the said envelope forming the filter is made of an elastically deformable material.

The opposite part of the filter to the bottom of the filter may have a shoulder intended to bear against an annular surface of the filter holder when they are mounted on the machine and when there is a clearance between the said annular surface and the shoulder before the filter holder and filter assembly is mounted on the machine. This alternative form of embodiment makes it possible, when fitting the filter holder and filter on the machine, to create a seal by compressing the filter between the coffee machine and the filter holder, the shoulder making the seal between the annular surface of the filter holder and the machine.

According to an alternative form of embodiment, the plate has at least one projection which becomes housed in an annular recess at the bottom of the infusion chamber, the diameter of which recess is greater than the diameter of the said infusion chamber so as thus to prevent the plate from leaving the bottom of the infusion chamber inadvertently. What actually happens is that since the plate is not fixed to the protrusion, it has to be able to remain trapped at the bottom of the infusion chamber, particularly during cleaning or when the filter holder is inverted, for example in a draining rack.

According to another alternative form, the infusion chamber comprises at least one longitudinal milling on its interior surface, the dimensions and shape of which correspond to those of the projection of the said plate so as to allow the plate to be fitted at the bottom of the infusion chamber. What actually happens is that in order to be able to introduce the plate into the infusion chamber it is necessary to provide at least one milling so as to slide the plate to the bottom of the infusion chamber using the longitudinal milling as a guide for the projection of the said infusion chamber. Once the bottom is reached, the plate needs merely to be turned through a few degrees so that it can no longer accidentally slide out of the infusion chamber, while at the same time remaining free to rock with respect to the protrusion.

According to another alternative form, the protrusion is equipped with means so that the position of the said plate can be adjusted with respect to the protrusion.

According to another alternative form, the filter is a cartridge containing a dose of coffee and closed on its opposite face to the bottom of the filter by a layer of a material that allows water through.

Finally, according to another alternative form, the filter is a reusable filter, that is to say that all that is required is for the desired quantity of coffee to be introduced each time into the filter and for the coffee to be made as is often the case in known machines employing a metal filter.

According to another embodiment, the filter holder comprises at least deformable means for closing off the bottom of the filter in contact with the said bottom, support means collaborating with the said means for closing off the bottom of the filter so as to allow the said closure means to deform and the coffee to flow when the pressure in the filter reaches a determined level.

The deformable closure means preferably comprise a plate and the support means are formed of a land in the infusion chamber and at least two lateral projections on the plate.

As a preference, the plate comprises three lateral protrusions evenly spaced around the periphery of the plate and pressing against the land of the infusion chamber.

The filter which forms the coffee receptacle may be a disposable or non-disposable cartridge, or alternatively may be a reusable filter.

The advantages of the system according to the invention are many. In particular, the construction is very simple and actually produces quality froth by throttling the coffee extract, at least once, or even more often depending on the embodiment. The system is also very reliable and does not easily become soiled. In addition, the volume in which the coffee extract is pressurized before it can escape from the filter holder is larger than it is in the systems already known from the prior art, which means that the froth generation is further enhanced as a result.

The invention will be better understood through the description of several embodiments thereof and the figures relating thereto.

### BRIEF DESCRIPTION OF THE DRAWINGS

FIG. 1 depicts a section view of a first embodiment of a filter holder according to the invention;

FIG. 2 depicts a view from above of the filter holder of FIG. 1, but without the filter;

FIG. 3 depicts two alternative forms viewed from above of a moving plate according to the invention;

FIG. 4 depicts a third alternative form of moving plate in a filter holder in section according to the invention;

FIG. 5 depicts a second embodiment of a filter holder according to the invention, viewed in section;

FIG. 6 depicts two alternative forms, viewed from below, of a fixed plate according to the invention, and

FIG. 7 depicts various fixed-plate hole shapes, in part section.

FIG. 8 depicts a section view of another embodiment of the filter holder according to the invention;

FIG. 9 is a view in section on II-II of FIG. 8;

FIGS. 10A to 10D are a schematic depiction of the deformation of the filter when coffee is being made;

FIG. 11 depicts a section view of another embodiment of the filter holder according to the invention;

FIG. 12 depicts a view from above of the filter holder of FIG. 11, without a coffee filter;

FIG. 13 depicts a view from above of one embodiment of a deformable plate according to the embodiment of FIG. 11.

### DETAILED DESCRIPTION OF THE PREFERRED EMBODIMENTS

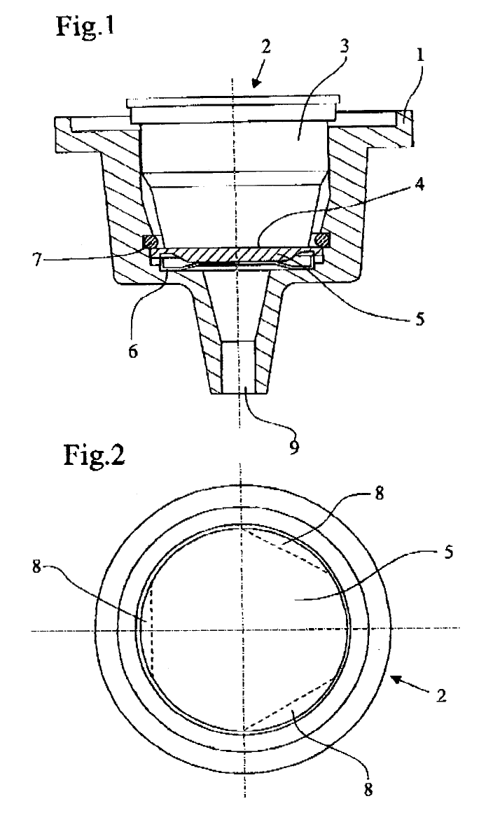

The first embodiment of the invention is described with reference to FIG. 1. In this figure, the filter holder 1 of a coffee machine of the espresso type has the form of a bowl with an infusion chamber in which a coffee filter 2 is placed. This coffee filter is known in the prior art and may adopt the form of a reusable filter, generally made of metal, as in the machines more commonly intended for professional use, or of a disposable cartridge, such as those intended more commonly for domestic use. This filter in general and in the known way comprises a part forming a container 3 into which the ground coffee is introduced and a pierced bottom 4 forming the actual filter and possibly covered with a fabric or paper membrane holding back the coffee grounds, but allowing liquid coffee extract through.

Underneath the filter 2 there is a moving closure plate 5 which is pressed against the pierced bottom 4 of the filter 2 by a sprung means 6. The said sprung means for its part bears against the bottom of the infusion chamber. The moving closure plate 5 and the sprung means 6 are held inside the filter holder by means of a removable pin 7.

The way in which the system according to the invention works is as follows: in the conventional way, hot water is introduced under pressure by means of a pump into the filter and wets the coffee grounds. The liquid pressure obtained in the filter holder is of the order of 8 to 15 bar. As the bottom 4 of the filter 2 is pierced, the pressure inside the filter is applied directly to the moving closure plate 5 against the spring 6. When the pressure of the liquid in the filter 2 is high enough to overcome the force applied by the sprung means 6, the moving closure plate 5 moves axially towards the bottom of the infusion chamber.

The moving closure plate 5, in a first alternative form, has the shape of a disc as depicted in FIG. 2. The clearance between the periphery of the closure plate 5 and the infusion chamber of the filter holder 1 is of the order of 3 to 5 hundredths of a millimetre, or even more. As soon as the plate 5 has moved away from the bottom 4 of the filter 2 towards the bottom of the infusion chamber, the coffee extract will be able to escape from the filter 2, passing around the plate, and will flow through the flow hole 9 into a container placed under the filter holder. In an alternative form depicted schematically in FIG. 2 by dotted lines indicated on the surface of the plate 5, this plate has at least three cut-outs 8 in its periphery, these cut-outs 8 facilitating the flow of the coffee extract.

In contrast to the known systems, the system according to the invention uses a reversible principle which means that a minimum pressure needs to be maintained in the filter 2 in order for the coffee extract to be able to flow. As soon as the pressure drops, the spring 6 brings the moving plate 5 back against the filter and the flow of coffee extracts ceases.

The principle of the invention therefore at least throttles the coffee extract as it leaves the filter, and the consequence of this is improved froth production on the coffee extract collected through the flow hole 9.

As a preference, the return force of the spring is of the order of 40 kilos. Of course, this value can be varied if necessary. Likewise, the shape of the spring 6 is given merely by way of example and other springs remain within the context of the principle of the present invention.

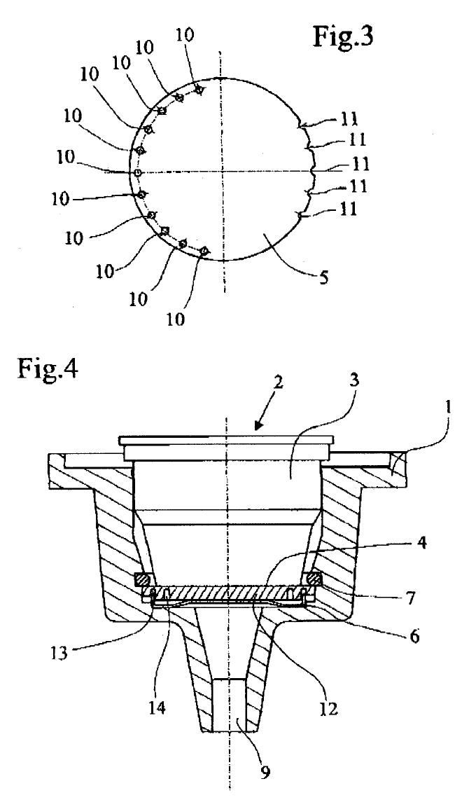

By way of example, the moving plate has the shape of a disc as depicted in FIG. 2, possibly with three cutouts evenly spaced around the circumference (depicted schematically in dashed line). Other alternative forms of moving plate are possible and are depicted in FIG. 3.

In this figure, two possible alternative forms are depicted on each half of a moving plate 5, these alternative forms calling upon means equivalent to the cut-outs 8 of FIG. 2. In the first alternative form (left-hand half of the plate 5) a series of holes 10 has been pierced near the outer edge of the plate 5 and these, like the cut-outs 8, allow the coffee extract to escape from the filter 2 when the pressure in the said filter is high enough. The holes 10 may be straight-through holes or may have the shape of a venturi.

In the right-hand half of the plate 5, the cut-outs 11 are formed directly in the outer edge of the plate 5 and have the same function as the holes 10 or of the cut-outs 8 (FIG. 2). These cut-outs 11 may have a constant axial dimension, or alternatively may have the shape of a half venturi.

In FIG. 4, a third alternative form of moving plate is depicted in a filter holder 1 similar to the one of FIG. 1. In this figure, identical elements already described have the same references. The filter holder 1 contains, in an infusion chamber, a filter 2 (made of metal or disposable cartridge) formed of a receptacle 3 having a pierced bottom 4, possibly covered with a filter membrane. Under the filter 3 there is a moving plate 12 pressed against the bottom 4 of the filter 3 by a spring 6 pressing against the bottom of the infusion chamber. The entity is held in position by means of the pin 7. This plate 12, similar to the plates described in FIGS. 2 and 3, further comprises two concentric grooves 13 and 14. These two grooves create a pressure drop in the coffee extract as the latter passes to the other side of the plate 12, that is to say that the pressure in the filter 2 is sufficient, also encouraging the production of quality froth in the coffee extract obtained at the outlet from the infusion chamber (flow hole 9).

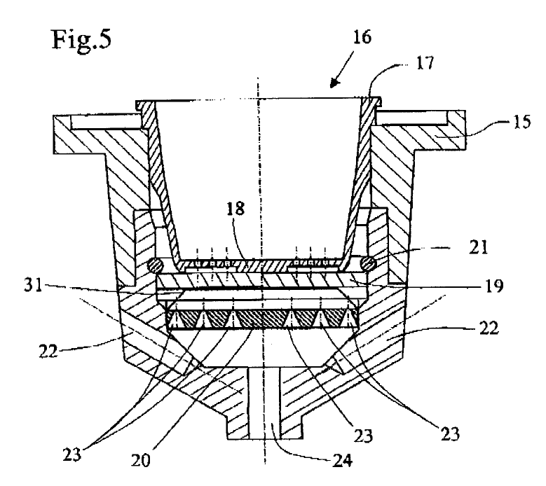

A second embodiment of the invention is described with reference to FIG. 5. The filter holder 15 has, in a similar way to the first embodiment, an infusion chamber in which a coffee filter 16 is placed. This coffee filter is known from the prior art and may adopt the form of a reusable metal filter, as in machines intended for professional use, or of a disposable cartridge, such as those intended for domestic use. The filter generally and in the known way comprises a part forming a container 17 into which the ground coffee is introduced, and a pierced bottom 18 forming the actual filter and possibly covered with a fabric or paper membrane holding back the coffee grounds but allowing the liquid coffee extract through. This filter is similar to the filter 2 described in conjunction with the first embodiment of the filter holder (FIGS. 1 and 4).

Underneath the filter 16 there is a moving closure plate 19 which is pressed against the pierced bottom 18 of the filter 16 by a sprung means 31. The said sprung means 31 for its part bears not against the bottom of the infusion chamber as in the first embodiment, but against the second plate 20 which is fixed with respect to the infusion chamber. The two plates 19, 20 and the sprung means 31 are held inside the filter holder 15 by means of a pin 21. The lower part of the filter holder 15 also comprises two air intakes 22. The sprung means used may be similar to the spring depicted in FIGS. 1 and 4 for example.

A second plate has a number of openings 23 which, in FIG. 5, have the shape of a venturi. In this embodiment, as in the previous embodiment, it is necessary for the pressure in the filter to reach a certain level in order for the moving plate 19 to move and allow the coffee extract out. This coffee extract therefore experiences a first throttling as it leaves the filter 16. Then, by virtue of the second plate 20 and the openings 23, the coffee extract is constrained for a second time and this encourages froth to form on the coffee extract collected through the flow hole 24 of the infusion chamber.

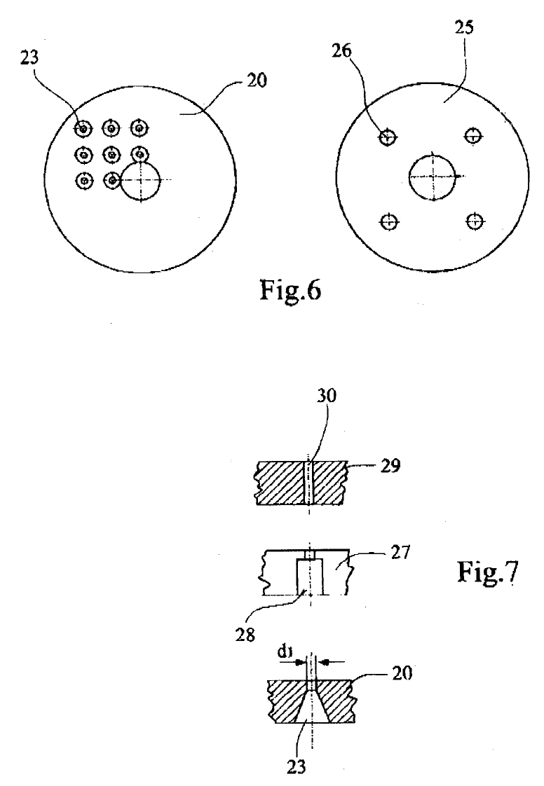

Two alternative forms of the second plate are depicted in FIG. 6. In the first alternative form, the plate 20 corresponds to the one depicted in FIG. 5. This plate comprises twenty-four holes 23 distributed uniformly on the plate 20. These holes have the shape of a venturi. In the second alternative form, the plate 25 has four holes 26 which are straight through.

As indicated, the holes in the second plate 20 may have the shape of a venturi 23 or may have other shapes. Several alternative forms are depicted in FIG. 7 by way of non-limiting example. In the first from the bottom, it is the plate 20 with venturi-shaped holes 23. By way of example, the small diameter d1 is of the order of 0.4 mm and the venturi code angle is 45°.

In the second example, the plate 27 has holes 28 which have two different diameters. By way of example, the small diameter is of the order of 0.4 mm and the large diameter is of the order of 1.5 mm.

In the third example, the plate 29 has holes 30 of constant diameter, for example 0.4 mm. These various configurations may, of course, be combined with each other and the plate may have holes of different shapes, such as those depicted in FIG. 7.

The moving plate 19 may have the same shape as those described in conjunction with the first embodiment of the invention (see FIGS. 1 to 4 and the corresponding description hereinabove).

The springs may also have various and varied shapes, such as the shape of spring washers or other equivalent shapes for example.

The various alternative forms of plate described hereinabove may, of course, be combined with each other at will. In addition, retaining means equivalent to the pins 7 and 21 described hereinabove may be anticipated for performing the same function.

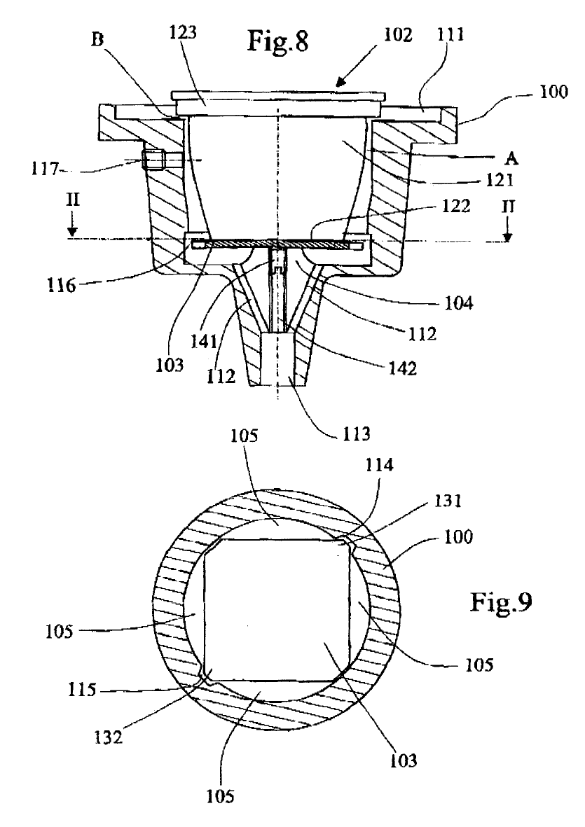

In the embodiment of FIG. 8, the filter holder 100 of a coffee machine of the expresso type has an infusion chamber in which a coffee filter 102 is placed. This coffee filter is known from the prior art and may adopt the form of a reusable filter, as in the machines more commonly intended for professional use, or of a disposable cartridge, such as those intended more commonly for domestic use. This filter generally and in the known way comprises a part forming a container 121 into which the ground coffee is introduced and a pierced bottom 122 forming the actual filter and possibly covered by a fabric or paper membrane, particularly in the case of a cartridge holding back the coffee grounds, but allowing the liquid coffee extract through. It is important that the envelope forming the container 121 be made of an elastically deformable material so that, on the one hand, the filter can be deformed by the compression to which the filter will be subjected when the filter holder 100 and filter 102 assembly is fitted into the machine and, on the other hand, so that this envelope can also deform in the radial direction under the effect of the pressure when hot water is introduced for making the coffee as will be explained hereinafter.

Likewise, it is very important that there be a clearance A between the side wall of the container 121 and the infusion chamber and a clearance B between a shoulder 123 of the upper part of the filter 102 and an annular surface 111 of the filter holder 100. This is because this clearance B will be taken up when the assembly is fitted into the machine, and this will also make it possible to create a seal between the upper part of the filter holder 100 and the coffee machine. Of course, if the filter does not have a shoulder, then there is a seal provided between the machine and the filter holder.

The bottom of the infusion chamber has a central protrusion 104 on which there rests a plate 103 leaving passages 105 (FIG. 9) for the coffee to flow. The bottom of the infusion chamber has channels 112 leading to a flow hole 113 at the bottom of the filter holder 100 through which the coffee extract and of course the froth passes. The bottom of the filter holder also ends in a recess 116 the diameter of which is slightly greater than that of the infusion chamber of the filter holder 100. The plate 103 is equipped with two projections 131 and 132 (FIG. 9) which become housed inside the said recess 116 to prevent the plate 103 inadvertently or accidentally leaving the bottom of the filter holder. Indeed the plate 105 is not fixed to the protrusion 104 but is simply placed and can rock, admittedly within certain limits defined by the dimensions of the plate 103 and of the recess 116 for the reasons which will be explained later.

In order to be able to fit the plate 103, the infusion chamber has two millings 114 and 115 the position and shape of which allows the plate 103 to be slid along these millings which are used as a guide for the projections 131 and 132 of the said plate. Once the plate is at the bottom, all that it needs is for this plate to be turned through a few degrees so that the plate cannot accidentally come out. When there is a desire to remove the plate in order to clean the filter holder, all that is required again is for it to be turned slightly so that the projections 131 and 132 face into the millings 114 and 115 and for the plate to be removed, either using the fingers or using a tool that comes with the assembly, or even by turning the holder upside-down.

The shape of the plate 103, the number of projections used and therefore the number of millings is not limited and can vary according to the design. It is also possible to restrict the number to just one projection and just one milling. It is equally possible to provide other ways of retaining the plate 103 at the bottom of the infusion chamber of the filter holder 100 while at the same time allowing it to rock freely about the protrusion 104.

In an alternative form, provision is made for the possibility to adjust the position of the plate 103 with respect to the protrusion 104 by means, for example, of a screw 141 housed in a tapping 142, thus making it possible to move the plate, for example upwards, even if only to adjust the compression experienced by the filter as the filter holder and filter assembly is fitted into a machine.

Finally, the filter holder may also be equipped with an air intake 117 closed by a valve, which allows air in to adjust the pressure inside the infusion chamber and make it easier for the beverage to flow.

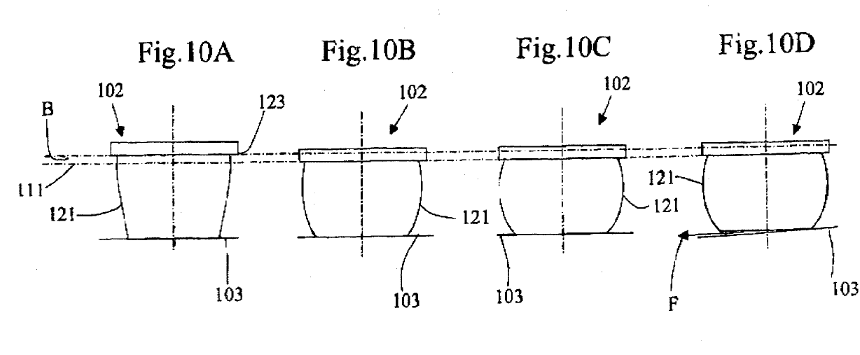

We shall now explain the operation of this embodiment with the aid of FIGS. 8 and 10A to 10D.

Having placed inside the filter holder 100 the filter 102 which may be either a cartridge or a reusable filter, we take the assembly to a machine of the expresso type and during fitting (for example a bayonet system which allows the filter holder to be clamped against the machine), the filter 102 is pressed against the filter holder 100 until the shoulder 123 presses against the annular surface 111 of the filter holder 100 thus creating a seal and the filter deforms elastically by a deformation in the radial direction of the periphery of the container 121.

FIG. 10A schematically illustrates the filter 102 with two lines in chain line illustrating the surface 111 of the filter holder 100 and the clearance B there is before the filter holder and filter are fitted into the machine.

FIG. 10B depicts the situation when the filter holder is placed on the machine and we can see that the lateral surface of the filter 102 has been deformed radially under the effect of the compression, that is to say of the crushing of the cartridge or of the filter 102. Of course, the plate 103 cannot move inside the infusion chamber. It is important that this crushing be taken up by this elastic deformation of the side wall of the container 121 as depicted in FIG. 10B.

In FIG. 10C, the hot liquid begins to flow under pressure which is usually between 8 and 15 bar inside the filter which further increases the radial deformation of the container 121. At a given moment, under the effect of this radial deformation of the container 121 and because the pressure at the bottom of the container 121 is not absolutely symmetric this means that the bottom of the container 121 detaches slightly from the plate 103, even if only because of the deformation of the lateral surface of the filter 102 which causes the plate 103 to rock about the protrusion 104 letting liquid escape in the direction of the arrow F. This rocking as depicted is just one example, but the plate 103 can rock in all directions depending on this asymmetry created by the pressure and the deformation of the filter.

The coffee extract leaving the filter is thus throttled by crushing molecules of fat contained in the coffee, and this has the result of producing improved froth on the coffee extract collected subsequently through the channels 112 and the flow hole 113. As soon as the pressure inside the filter decreases because the coffee has begun to flow, the filter tends to return to its initial shape because of the elastically deformable material, and this means that the plate 103 returns to its initial position, and as soon as the pressure increases because there is no flow, further rocking on the same side or on some other side occurs and the liquid continues to flow. This approach makes it possible to wet the coffee sufficiently to create an infusion that has a good taste and the subsequent throttling makes it possible to obtain a thick froth of excellent quality and persistence.

According to the alternative form of embodiment in which an adjusting screw 141 is provided, the position of the plate 103 can be adjusted within certain limits precisely so as to increase or decrease the initial compression to which the filter 102 is subjected upon fitting into a machine, and this also has a knock-on effect on the pressure value that will allow the plate 103 to rock in order to allow the coffee and the froth to escape.

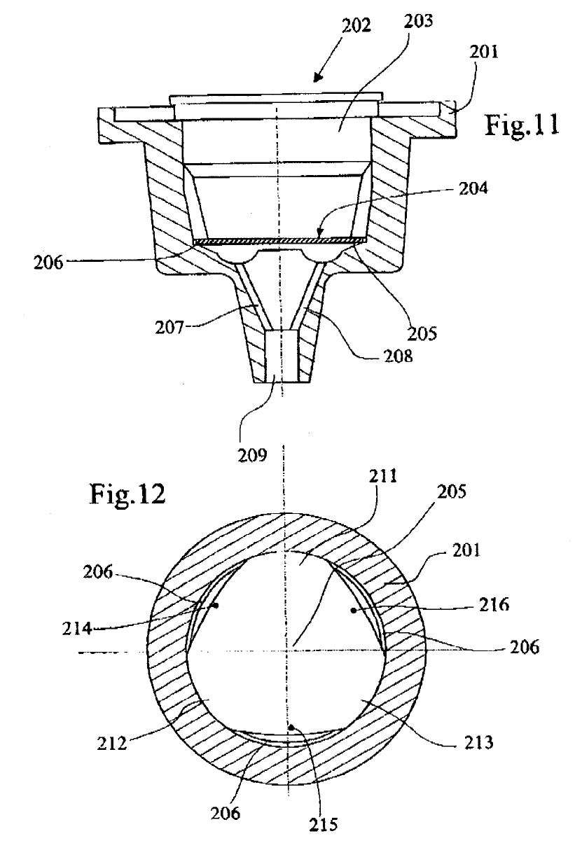

In the third embodiment of FIG. 11, the filter holder 201 of a coffee machine of the expresso type has an infusion chamber in which a coffee filter 202 is placed. This coffee filter 202, which forms a ground coffee receptacle, is known in the state of the art and may adopt the form of a reusable filter, generally made of metal, as in machines more commonly intended for commercial use, or of a disposable cartridge, such as those intended more commonly for domestic use. This filter 202 generally and in a known way comprises a part forming a container 203 to which the ground coffee is introduced and a pierced bottom 204 forming the actual filter, possibly covered with a fabric or paper membrane holding back the coffee grounds, but allowing the liquid coffee extract through.

Underneath the filter 202 there is a deformable closure plate 205 which is pressed against the pierced bottom 204 of the filter 202 by a land 206 cut into the bottom of the infusion chamber.

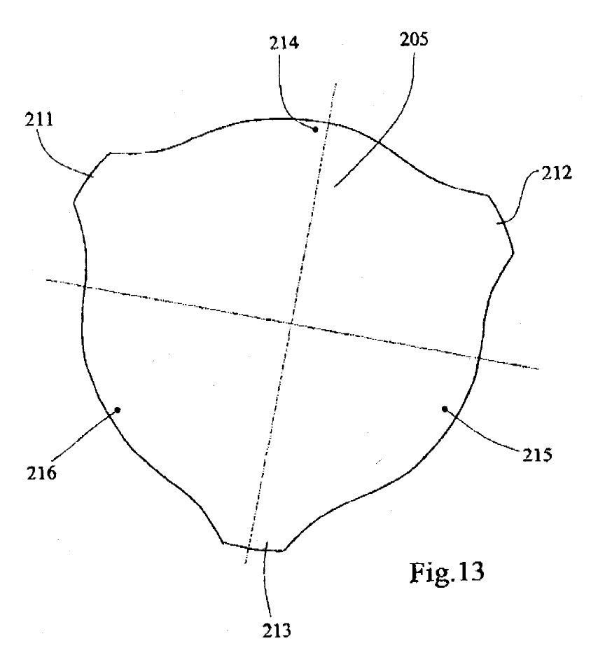

The deformable plate is described in greater detail with reference to FIGS. 12 and 13. In FIG. 12, a filter holder is depicted in section, viewed from above but without a filter. The filter holder 201 has a cylindrical overall shape in which the plate 205 is placed resting against the land 206 which preferably extends over the entire inside diameter of the filter holder 201.

The plate 205 (FIGS. 12 and 13) has the overall shape of a disc and preferably comprises three lateral projections 211, 212 and 213 which extend in the plane of the plate 205. These projections 211, 212 and 213 are preferably formed such that they are evenly distributed around the periphery of the plate 205, for example every 120° when considering the middle of each projection 211, 212 or 213.

The way in which the system works is as follows: in the conventional way, hot water is introduced under pressure by means of a pump of the coffee machine into the filter and wets the ground coffee. The liquid pressure obtained in the infusion chamber is of the order of 8 to 15 bar. As the bottom 204 of the filter 202 is pierced, the pressure inside the filter 202 is applied directly to the plate 205, the latter being pressed against the bottom 204 of the infusion chamber by the land 206 against which the projections 211, 212 and 213 of the plate 205 bear.

When the pressure of the liquid in the filter 202 is sufficient, the plate 205 deforms elastically towards the bottom of the filter holder 201, and the coffee flows through the regions 214, 215 and 216 which lie between the projections 211, 212 and 213. As a preference, the operating pressure of the system is then of the order of about 13 bar.

This deformation then allows the coffee to flow between the plate 205 and the bottom 204 of the infusion chamber, then into the channels 207, 208 and the flow hole 209 to finish off in a container (not depicted) such as a cup.

The principle of the invention therefore is at least to throttle the coffee as it leaves the filter by crushing the molecules of fat contained in the coffee, and this has the result of improved production of froth on the coffee extract collected by the channels 7, 8 and the flow hole 9.

In contrast to the known systems, the system according to the invention uses a reversible principle which means that a minimum pressure needs to be maintained in the filter 202 in order for the coffee to be able to flow. As soon as the pressure drops, the plate 205 straightens against the filter 202 and the flow of coffee ceases.

Preferably, the return force of the plate 205 is of the order of 40 kilos. Of course, this value can be varied if necessary. The plate 205 may be made of any deformable material according to the principle of the invention and which is acceptable for this type of application. For example, use may be made of a plate 1 mm thick made of anticorrodal.

The filter holder can be independent element which is mounted on a coffee machine, for example through a bayonet system, or it can also be integrated into the coffee machine to form an entirely automatic system.

What is claimed is:

1. Coffee filter holder with an infusion chamber, the bottom of which has an opening allowing the coffee extract to flow through, with a filter with a bottom having a hole, wherein the infusion chamber comprises at least:
means for closing off the filter bottom;
support means collaborating with the said means for closing off the filter bottom so as to allow the said closure means to be removed and the coffee extract to flow when the pressure in the filter reaches a determined level.

2. Filter holder according to claim 1, wherein the said moving closure means comprise a first moving plate (5) collaborating with at least one sprung element (6; 31).

3. Filter holder according to claim 2, wherein the first plate (5) has at least one opening (8; 10; 11).

4. Filter holder according to the preceding claim, wherein the first plate (5) has several openings (8; 10; 11) distributed around its circumference.

5. Filter holder according to claim 2, wherein it comprises a second plate (20; 25; 27; 29) having at least one opening (23; 26; 28; 30), the said pressure means (31) acting between the said second plate and the said first plate.

6. Filter holder according to one of the preceding claims, wherein the openings (23) are shaped as a venturi.

7. Filter holder according to claim 2 or 3, wherein the plate (12) has at least one concentric groove (13, 14) on its opposite face to the coffee receptacle (2; 16).

8. Filter holder according to claim 1, wherein the said closure means are formed of a deformable plate (103, 205) and the support means are formed of a land in the infusion chamber.

9. Filter holder according to claim 8, wherein the said land is a central protrusion (104).

10. Filter holder according to claim 8, wherein the said plate (103) has at least one projection (131, 132) which becomes housed in an annular recess (116) situated in the bottom of the infusion chamber, the said recess having a diameter greater than the diameter of the infusion chamber so as to prevent the plate (103) from accidentally leaving the bottom of the infusion chamber.

11. Filter holder according to claim 10, wherein the infusion chamber has at least one longitudinal milling (114, 115) on its interior surface, the dimensions and shapes of which milling correspond to those of the projection (131, 132) of the said plate (103) so as to allow the plate to be fitted at the bottom of the infusion chamber.

12. Filter holder according to claim 11, wherein means (141) are provided to allow the position of the plate (103) to be adjusted in the heightwise direction of the infusion chamber.

13. Filter holder according to claim 8, wherein the said deformable plate has at least two lateral projections (211, 212, 213).

14. Filter holder according to claim 8, wherein the plate (205) has three lateral projections (211, 212, 213) evenly distributed at the periphery of the plate (205) and bearing on the land (206) of the infusion chamber.

15. Filter holder according to one of the preceding claims, wherein the coffee receptacle is a cartridge or a reusable filter or a disposable coffee prepackaged dose.

16. Filter holder according to claim 15, wherein the cartridge is elastically deformable.

17. Coffee machine, characterized by a filter holder according to one of the preceding claims.
